(19) United States
(12) Patent Application Publication
(10) Pub. No.: US 2014/0156348 A1
(43) Pub. Date: Jun. 5, 2014

(54) SYSTEM AND METHOD FOR INVENTORY MANAGEMENT

(71) Applicant: Dimitri Sinkel, Lunenburg, MA (US)

(72) Inventor: Dimitri Sinkel, Lunenburg, MA (US)

(21) Appl. No.: 14/094,923

(22) Filed: Dec. 3, 2013

Related U.S. Application Data
(60) Provisional application No. 61/732,552, filed on Dec. 3, 2012.

(51) Int. Cl. G06Q 10/08; G06Q 30/02

(52) U.S. Cl. CPC G06Q 10/087; G06Q 30/0202
USPC 705/7.31

(57) ABSTRACT

An inventory management system and method computes a safety stock level for each day of the week based on specific historical data for that day of the week, independent of other days in the sales cycle. The inventory management system therefore accommodates cyclic trends over different days of the week (or other sales periods) to identify a forecast error specific to the day of the week, rather than an average over many days, and allow for a safety stock level as recorded by surges on a particular day due to random factors. The generated safety stock levels generate for each SKU (Item at a location) inventory replenishment criteria streamlined to order only those quantities needed to maintain the safety stock level, and further assure that a near complete in-stock percentage (such as 95% or 97%) is maintained. The system generates ordering quantities that are specific to the day of the week calculated over a week of sales.

### RELATED APPLICATIONS

This patent application claims the benefit under 35 U.S.C. §119(e) of U.S. Provisional Patent App. No. 61/732,552, filed Dec. 3, 2012, entitled “SYSTEM AND METHOD FOR INVENTORY MANAGEMENT,” incorporated herein by reference in entirety.

### BACKGROUND

Historically, inventory control systems relied upon amassing sufficient quantities of goods at or near the location where they were to be consumed, sold, or manufactured into other goods. Particularly in an environment with many different items, it was more problematic to track diminishing quantities of individual items than to maintain a relatively large stock of all or most items. Large warehouse space was often needed near a distribution or consumption point, such as a retail store. As with most industries, computer based innovations facilitated efficiency, and the use of information technology such as databases and stock management such as bar (UPC) codes became commonplace. Bar codes allowed rapid inventory updating, so that the granularity of shortfalls and reordering needs became specific to individual items. It was no longer necessary to maintain large warehouses or stock areas because a shortfall in a particular item was identifiable, and inventory shipments could be tailored to specific items.

### SUMMARY

An inventory management system and method computes a safety stock level for each day of the week based on specific historical data for that day of the week, and its context in a weekly sales cycle. The inventory management system therefore accommodates upward and downward trends over different days of the week (or other sales periods) to identify a required safety stock quantity specific to the day of the week, rather than an average over many days, and plans for a safety stock level as recorded by surges on a particular day due to random factors. The generated safety stock levels indicate a per-item inventory replenishment criteria streamlined to order only those items needed to maintain the safety stock level, and further assure that a targeted in-stock percentage (such as 95% or 97%) is maintained.

Configurations herein are based, in part, on the observation that modern information processing systems and product labeling, including bar codes and RFID (Radio Frequency ID) tags, allow inventory levels to be updated continuously with sales, as an item is deleted from inventory concurrent with a scan of the product ID (i.e. bar code) at a point of sale (POS) register. Retail locations do not need to engage in global or all-encompassing inventory replenishment or manual inventory practices, since the POS and inventory tracking systems identify product levels (inventory) in a continuous, real-time manner.

Unfortunately, conventional approaches to inventory management suffer from the shortcoming that safety stock inventory levels are not optimally calculated for each day of the week. Accordingly, configurations herein substantially overcome the above described shortcomings by generating safety stock quantities that are specific to a day of the week (or other sales period) calculated over a week of sales. A safety stock also addresses variations in observed trends, as which might occur from external events. In contrast to conventional approaches, computation of safety stock and accommodating the safety stock quantities for stock replenishment orders, mitigates stocking shortfalls that can arise from conventional order cycles for retail stock. The safety stock takes into account variations over days of the week shown by previous sales history. Such variations are unique to retail stock, due to variations in consumer activity, and are not found in other stocking contexts such as manufacturing or services.

A Daily Retail Inventory Service Target (DRIST) system and model is based on statistical inference of systematic bias and random error of historic POS sales data, utilizing a Day of the Week (DOW) analysis over a Variable Forecast Interval (VFI), and therefore optimizing inventories in a retail environment. The DRIST model sets a target customer service level (Service Target), for example, 95%, and automatically drives down inventories to their lowest possible level while assuring that the Service Target is realized every day, for every product, at every location. The proposed approach smoothes out the day to day fluctuations often seen in In-Stocks, orders, shipments, and inventories. Maintaining the in-stock percentage at the Service Target ensures customer loyalty and reduces lost sales while simultaneously reducing inventory requirements and cutting inventory carrying costs. The resulting mitigation of fluctuations in inventories, orders, and shipments further improves overall efficiency of operations.

The service target specifies the percentage of locations that are expected to be in stock with a particular item at any given time. It should also be emphasized that in the context of this discussion an item at a location is designated as a SKU (stock keeping unit), thus the same product offering at two different locations designates two separate SKUs. Put another way, a SKU represents attributes of a sale offering and may include manufacturer, product description/type, material, size, color, and packaging, in addition to location, for example.

The DRIST Model utilizes a Variable Order Interval (VOI) which accommodates this fixed order cycle and computes a Safety Stock Quantity (SSDOW) including all the safety stock requirements until the next order can be placed. Since the disclosed approach is specific to each day of the week, and to each item in inventory, surpluses and shortages that occur with daily averaging are avoided. Such a sales period oriented approach avoids depletions that can occur with high volume items during a spike in demand, and avoids excess stock of slower moving inventory that consumes unnecessary retail and transport resources.

With the level of granularity and the relatively low levels of inventory based on daily deliveries, it is beneficial to calculate precise demand variability, down to the daily demand detail level. In fact, with a daily delivery model, it is quite inaccurate to reference average demand and average variability over any period longer than one day. The DRIST Model computes the optimized Day-of-the-Week Safety Stock Quantity (SSDOW) based on a daily, DOW analysis for bias and error.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of an inventory management environment suitable for use with configurations herein;

FIG. 2 is a flowchart of inventory management in the system of FIG. 1;

FIG. 3 depicts safety stock in the managed inventory of FIG. 1;

FIG. 4 shows differences in inventory levels between conventional approaches and the configurations disclosed herein; and

FIG. 5 shows inventory levels (in-stock %) based on the system of FIG. 2.

### DETAILED DESCRIPTION

A particular configuration, discussed as an example below, depicts the Daily Retail Inventory Service Target (DRIST) system and method for accommodating different sales periods presented by different days of the week and the sales and sales variability as indicated by previous history, typically 4-7 weeks of sales data.

Inventory management methods originally evolved to serve large manufacturers, and the conventional, well known Reorder Point (ROP) Model works well in that business environment. In retail, planners still generally manage safety stock levels empirically, usually as a number of days of forward coverage, based on experience. But whenever statistical methods are used, they are invariably variations of the ROP Model. Unfortunately, the ROP Model does not work well for retail, which is especially troubling because safety stock levels are so much more critical for retail goods.

In manufacturing, safety stock is a small part of the inventory compared with cycle stock which supports the actual sales. In retail, the opposite is true: safety stock comprises 60% to 90% of the total inventory. So, in retail, the effective management of safety stock actually has more impact than improving the forecast accuracy of sales, which only affects cycle stock. Until now, there has been little attention focused on improving inventory control in the retail sector—at distribution centers and stores.

Until recently, software and hardware capacities had not evolved to the point where they could support the volumes entailed in daily, store level retail planning. Thus, it was natural for early practitioners to try to apply the traditional Reorder Point Model (ROP) as a starting point to managing retail inventories. Such conventional approaches encountered at least three shortcomings:

1. Reorder Point is not useful in Retail which has a Fixed Order Cycle In manufacturing, planning cycles are measured in weeks and months, reflecting process durations and raw material batches. The ROP model calculates when to place the next order, based on average forecasted demand. In the retail environment, ordering is prescheduled within the planning cycle, usually every day or on certain days of each week, based strictly on the calendar.

2. Demand Variability is not Uniform—Day-of-the-Week Matters The ROP Model assumes variability is stable throughout the lead time and thus calculates safety stock as a function of average variability of demand and supply over the lead time. However, retail operations are very sensitive to variations by Day-of-the-Week (DOW), both in terms of the forecasted demand (sales velocity) and demand variability, the forecast error. Furthermore, the two are not necessarily related to each other. The highest daily forecast is often Saturday, but the highest forecast error often occurs on Sunday or Monday.

3. Forecasting Interval should align with Lead Time and Order Cycle The ROP model calculates demand variability based on forecasting models that use a weekly or monthly forecasting interval, with the implicit assumption that those intervals line up with order lead times. In the retail environment, where order lead times are measured in days rather than weeks, forecast error varies by DOW, and is not directly related to weekly forecast error. The DRIST Model computes forecast error over a Variable Forecast Interval (VFI), which is equal to the actual order lead time by DOW, plus the Variable Order Interval (VOI).

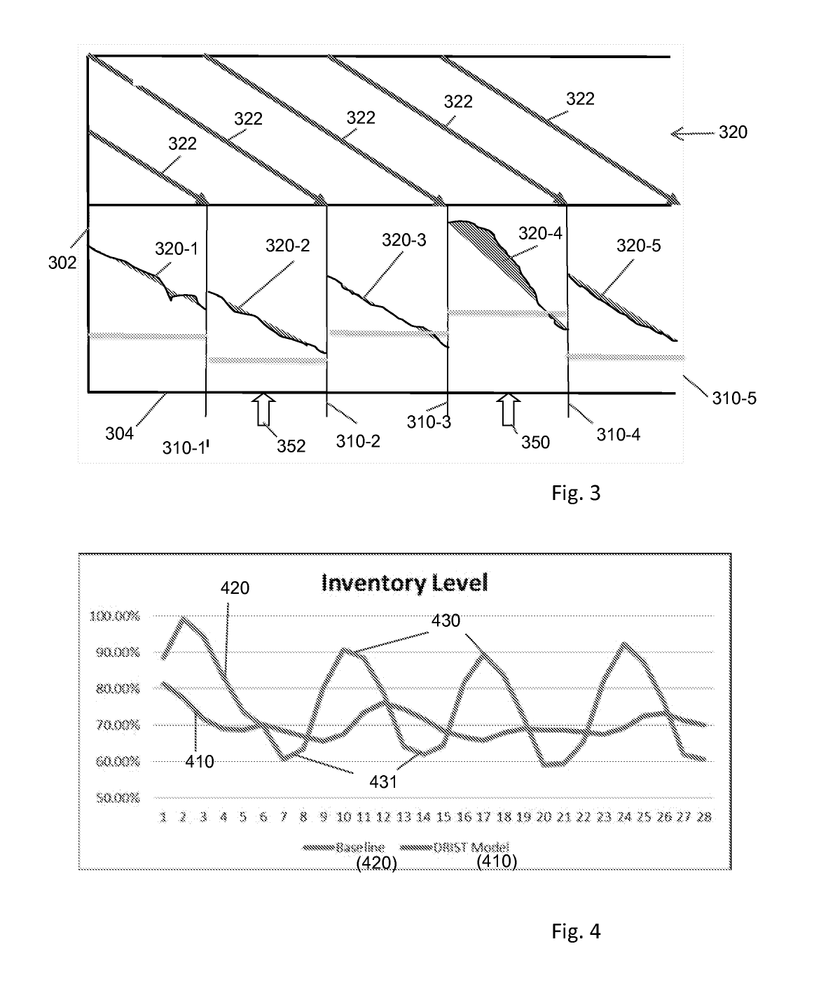

In real world retail applications, detailed below in FIGS. 3 and 4, the DRIST model has been proven to maintain reliable, consistent In-Stock levels, at or above the planner's Service Target, while reducing Inventory requirements to their lowest possible level. At the same time, the DRIST model smooths out the day to day fluctuations we often see in In-Stocks, orders, shipments, and inventories.

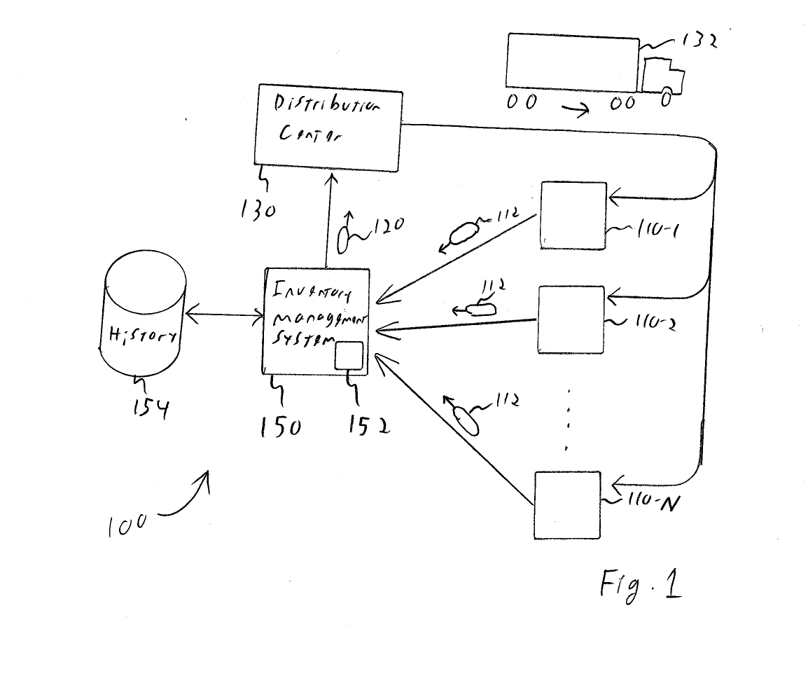

FIG. 1 is a context diagram of an inventory management environment suitable for use with configurations herein. Referring to FIG. 1, in an inventory management environment 100, a plurality of inventoried sites 110-1 . . . 110-N (110 generally) perform sales, manufacturing, or consumption of inventory. Retail locations for direct consumer sales exhibit the most volatile inventory patterns, due to the random nature and external factors affecting sales, however manufacturing facilities and sites that consume inventory (such as product integrators, internet shippers, etc. products used in the local facility) also benefit from inventory management as disclosed herein. Each site 110 sends sales data and historic forecast data 112 to the inventory management system (IMS) 150. The IMS includes one or more servers 152 executing the DRIST system as outlined herein, which may also be located at the individual sites 110, rather than in a central repository. The sales data includes inventory depletion statistics for each item, or SKU/UPC for each sales period, typically days, in the previous sales cycles (i.e. weeks), typically 4-7 weeks of inventory cycles. Inventory depletion refers to sites 110 that consume inventory with or without direct sales. In either case, the sales data 112 depicts item counts sold during each sales period. The server stores the data 112 as sales history in a repository 154, and employs the sales data 112 for generating orders 120 to replenish inventory, as discussed further below. The orders 120 include a set of items and a quantity for each item for maintaining the inventory level at the site 110. A vendor or distribution center 130 receives the orders 120 for fulfillment by inventory replenishment 132, typically truck deliveries, however any suitable delivery mechanism may be employed. Multiple vendors and/or distribution centers 130 may be employed, as each item has a specific count for reordering, and a specific lead time from ordering until arrival in inventory at the site 110. Inventory replenishment 132 then arrives at the sites 110 and is reflected in the inventory count. As indicated above, a particular feature is to compute the orders 120 such that a targeted percentage of locations (e.g. 95%) are in stock with a specified item (SKU) at any particular time.

Many retail ordering schemes rely on days of the week for sales periods and sales cycles. In one configuration, in an inventory management environment having inventory statistics, in which the inventory statistics are specific to each day of the week, the method of computing target inventory levels includes gathering, for each day of the week, inventory level statistics from previous sales. The method computes, based on the inventory level statistics, an inventory level for each day of the week, such that the safety stock accommodates variations in inventory between the different days of the week. The server 152 renders, for each of a plurality of items, a stocking level indicative of the target inventory level including the safety stock for each day of the week. The server 152 computes an ordering quantity based on a lead time such that the ordered quantity arrives to satisfy the rendered stocking level on the determined day of the week. Identifying the actual stock levels includes identifying stock levels on the day of the week from previous weeks from the history data in the repository 154, thus focusing on the same day of the week over time, rather than an average of all days in the week.

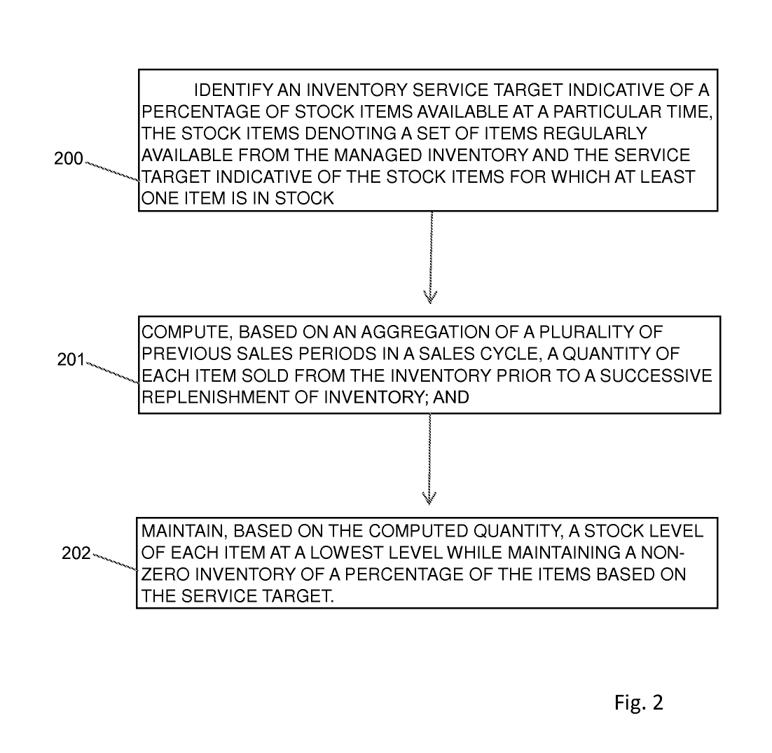

The sales period and cycle need not be limited to the days of the week. FIG. 2 is a flowchart of inventory management in the system of FIG. 1. Referring to FIGS. 1 and 2, at step 200, the method of managing inventory as disclosed herein includes identifying an inventory service target indicative of a percentage of stock items available at a particular time, such that the stock items denote a set of items regularly available from the managed inventory and the service target is indicative of the desired In-Stock level, equal to the percentage of stock items for which at least one item is in stock. The service target specifies the desired percentage of SKUs, (item at a location) for which at least one is in stock. In general, higher service levels cause the required safety stock levels to rise exponentially as the target approaches 100%, as it is difficult to predict all scenarios that permit in-stock status of all items.

The server 152 computes, based on an aggregation of previous sales periods in a sales cycle, a quantity of each item sold from the inventory prior to a successive replenishment of inventory, as depicted at step 201. The weekly sales cycle defines a sequence of sales periods (typically days), such that the aggregation of previous sales periods includes a set of corresponding sales periods in the sales cycle independently of other sets of sales periods. The result is that the corresponding sales periods are defined by similar positions in the sequence. In an example configuration, the sales period may be a day in a weekly sales cycle. In other words, the safety stock needed on a Saturday is based on previous sales data for N previous Saturdays, rather than N previous calendar days.

The server 152 renders orders 120 for maintaining, based on the computed quantity, a stock level of each item at a lowest level while maintaining a non-zero inventory of a percentage of the SKUs based on the service target, as shown at step 202. Typically these take the form of orders sent directly to one or more vendors or to one or more distribution centers 130 for fulfillment and delivery to the individual sites 110.

In configurations herein, the site 110 assigns, for each item of the set of regular stock items, a unique identifier denoting the particular item. Such identification may be done by a UPC (Universal Product Code) scanable bar code or RFID tag, or other suitable mechanism. Often, the identifier is equivalent to or mapped to a SKU (Stock Keeping Unit), common in vendor environments. Since the unique identifier is specific to a type of item and the location it is sold, the SKU of a particular item may differ from site 110 to site, even though the UPC symbol is the same.

The orders 120 invoke a replenishment mechanism for the item corresponding to each of the unique identifiers through the distribution center 130. To determine the safety stock, configurations herein compute a variable order interval based on lead times and an order interval forecast bias indicative of variations in expected demand, in which each item has an independent forecast bias for each sales period, thus avoiding generalizations that occur when sales are averaged over an entire week.

The server 152 computes a request to render an order quantity based on the computed safety stock for items in need of restocking, and generates the order quantity based on the current inventory and computed safety stock in an order 120. The server sends the generated order 120 to a replenishment facility such as the vendor or distribution center 130 operable to arrange a shipment 132 based on the order 120. In the example shown, the sales period corresponds to a day of the week and the sales cycle corresponds to a week, and the unique identifier denotes a SKU, or a type of product at a location, as indicated above. Alternate designations of sales periods, such as half days (12 hours) or even hourly may be appropriate in highly fluid environments.

As a stepwise process, the method computes a safety stock for each item by gathering for each item a history of inventory sold, and a history of sales forecasts, over the same or corresponding sales periods in the sales cycles (e.g. every Saturday). For each item of the plurality of items, the server 152 computes an expected quantity sold for each period of a sales cycle based on the history, and identifies, for each item, a deviation range of the expected quantity for each period. The server 152 aggregates, for the periods remaining until a replenishment of inventory, the deviation range, and computes the safety stock, thus addressing the nondeterministic aspects of the inventory prediction.

Aggregating the deviation range includes an aggregation of a forecast deviation for each day in the current ordering interval until a successive delivery of additional inventory for the item. The deviation range is based on a statistical parameter for maintaining a target percentage of items in stock (based on the % of locations having a particular items in stock, as discussed above). The safety stock needs to accommodate all sales periods, or days, until the next delivery, not just a single day of higher than average sales.

In a particular arrangement shown by the example herein, in an inventory management environment having historical sales statistics pertaining to day of week sales, the method of computing target inventory levels includes gathering, for each day of the week, forecast error statistics from previous sales, and computing, based on the forecast error statistics, a safety stock for each day of the week, in which the forecast error is independent of forecast error for other days of the week. The safety stock accommodates variations in forecast error between the different days of the week. The method then renders an order 120 indicative of the target safety stock for each day of the week. The order 120 involves computing an order quantity based on a lead time such that the ordered quantity arrives to satisfy the rendered stocking level on the determined day of the week. It should be emphasized that the safety stock encompasses the forecast error for each day until the next replenishment. Thus, the transport time from the vendor or distribution center 130 to each site 110 is considered. So if the next replenishment (delivery) is three days out, the safety stock encompasses additional stock in anticipation of variances for all three days. Since each SKU is specific to the site location, variations in lead time to the different sites is also covered.

FIG. 3 depicts safety stock in the managed inventory of FIG. 1. Referring to FIGS. 1 and 3, a safety stock covers the maximum expected variation for the sales period or periods until the next replenishment. The vertical axis 302 shows inventory levels, and the horizontal axis 304 depicts the succession of sales periods 310. The Safety Stock Quantity (SSDOW) is calculated for each period as a function of: Service Target, Forecast Error by DOW, Lead Time, VFI, and VOL Sales periods 310-1 . . . 310-5 (310 generally), such as days of the week (DOW) are shown as the vertical lines. The top portion 320 depicts the daily order lead times 322 from a distribution center (DC) directly to a store for meeting the inventory demand on the indicated period 310. Variation areas 320-1 . . . 320-5 (320 generally) indicate the fluctuating demand variability by DOW leading up to the end of the sales period 310, which meets the safety stock level 330-1 . . . 330-5 (330 generally) just as the inventory level approaches depletion, prior to the next replenishment. A higher safety stock 350 indicates an item having a greater variability of demand, while a lower safety stock 352 indicates a more stable item turnover rate.

FIG. 4 shows differences in inventory levels between conventional approaches and the configurations disclosed. Referring to FIGS. 1, 3 and 4, by maintaining inventory to include the safety stock 330, inventory levels may be kept more level, as shown by managed inventory level 410. In contrast, a conventional approach tends to follow a stocking level having more peaks 430 and valleys 431, indicating stocking levels well in excess of a safety stock level, then falling to a precarious level before replenishment, risking an item depletion (zero stock).

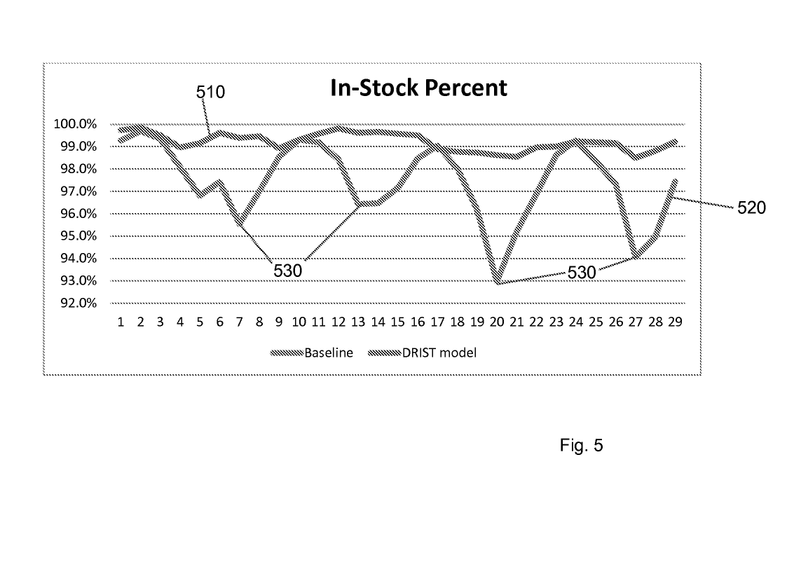

In the example of FIG. 5, an implementation of the disclosed approach achieved a 7.4% reduction in average daily inventory levels. This is a permanent reduction of inventory, reducing the requirement for working capital and liberating shelf space to add other products without expanding facilities. These improvements also reduce operating costs and boost profitability. Referring to FIG. 5, a stocking percentage 510 (in-stock %) of SKUs for the disclosed system are shown, along with in-stock percentages 520 for conventional approaches. The conventional approaches have substantial valleys 530, based on methodology that does not adequately recognize the difference in forecast error by the day of the week.

FIG. 5 shows inventory levels (in-stock %) based on the proposed and conventional (baseline) approaches. Planners never want to run out of stock, but they also want to minimize spoilage. Excess inventory not only incurs carrying costs, it may significantly contribute to waste as well. Spoilage is minimized when inventories are closely managed. Especially for products that are time sensitive, such as produce, where berries may spoil in 3-5 days, it is critical to manage inventory levels closely.

Depicted further below is a more detailed stepwise specification of the procedures and methods outlined above. The DRIST model analyzes forecast bias and error by day of week to set the most efficient safety stock value by store SKU (item at a location), based on daily variations. Frequent deliveries, often daily, allow the retail store to restock shelves directly rather than double handling product to the back room first, and then replenishing shelves in a second step. However, with frequent deliveries and short lead times, setting safety stock levels requires very precise calculation of demand forecast error by each DOW (Day Of Week), over each VFI. It is not possible to calculate retail safety stocks accurately from average demand and average forecast error, as is the case with most software solutions.

The Daily Retail Inventory-Service Target (DRIST) Model is intended for integration into any replenishment planning system. The DRIST model runs in a weekly batch process, as an automated, stand-alone, backend software program. It uses a weekly update of historic, daily point-of-sale (POS) sales, as well as historic allocated daily demand forecasts, to calculate forecast error and hence the daily safety stock requirements, by SKU, (by item and location).

The DRIST Model minimizes retail inventory levels while achieving desired Service Target levels. Features include the following:
A Day-of-the-Week (DOW) definition of a planning period for which point of sale (POS) and forecasting data is available, which can reflect one hour, one day, or some period of a number of hours in between, such as 8 hours or 12 hours. It is typically one 24 hour calendar day
A Variable Order Interval (VOI) for each SKU, which is the fixed order cycle for that SKU, rather than finding a reorder point.
A detailed analysis of Total Forecast Error, separating out the Forecast Bias from the Random Forecast Error.
A detailed analysis for every SKU (every item at every store) based on a Variable Forecast Interval (VFI), instead of the standard weekly forecast period.
Computation of the total Random Forecast Error over the VFI period, and applying it by the day of the week (DOW), instead of using the weekly forecast error.
Adding the Forecast Bias to the Safety Stock over the VOI period, to correct for the bias in the forecasted demand.
The calculation of the target safety stock level, SS_{DOW}, calculated by DOW for each day of arrival.

Outlined below are the computed quantities and descriptions. In a particular configuration, the disclosed formulas are expressed in a spreadsheet application, which lends itself well to a large number of items (SKUs).Accordingly, the disclosed method computes, fore each identified item at a location (typically a SKU or other unique identifier), a variation in the mean squared error over the variable forecast interval. It should be noted that a particular type of item may have a different SKU at different locations, for computing the safety stock levels per location for each item type. Each unique identifier therefore has a variable forecast interval, and the variable forecast interval is based on a predetermined granularity. The predetermined granularity may be any suitable period, such as includes days of the week, portions of days of the week (i.e. half days), and hours. In one example configuration, these may encompass computing mean squared error for each unique identifier for each day of week.

In the examples that follow, the major parameters and computations include the following:

SSDOW or SS_{DOW} is the safety stock quantity calculated for each Day-of-the-Week (DOW). It should be calculated each week for the next 2-3 weeks, based on historic forecast error information. Forecast error data should be generated using the most current history period of between 4 and 7 weeks. The SS_{DOW} is then set for each future day appropriate to its day of the week, for the following 2 to 3 weeks, and recalculated and re-set each week.

DOW reflects the Day-of-the-Week (DOW) definition of a planning period for which point of sale (POS) and forecasting data is available, which can reflect one hour, one day, or some period of a number of hours in between, such as 8 hours or 12 hours. The examples in this description use a calendar 24 hour DOW reflecting the retail selling week: Sunday, Monday, Tuesday, Wednesday, Thursday, Friday, and Saturday.

A Z-Factor is derived from tables for a one-tailed test for the Normal Distribution. It is used as a multiplier times the MIRFE to achieve the user's Service Target; for example, the following are just a few of the more common settings:
For 85% Service Target, Z=1.036
For 90% Service Target, Z=1.282
For 95% Service Target, Z=1.645
For 98% Service Target, Z=2.054
For 99% Service Target, Z=2.326

MIRFE is the Mean Interval Random Forecast Error, which is a summation of the Daily Random Forecast Errors (DRFE), counting back from the DOW day of arrival over the Variable Forecast Interval, for each day-of-the-week. For high velocity products, the VFI is typically anywhere from 2 to 9 days. The MIRFE reflects the mean squared error of the random error component over the VFI, most of which is the lead time.

VOIFB is the Variable Order Interval Forecast Bias, summed over the VOI Variable Order Interval, for each day-of-the-week. This portion of the safety stock calculation is designed to correct for the bias in the demand forecast in the cycle stock plan. For high velocity products, the VOI is typically 1 to 2 days. The VOIFB reflects the forecast bias that was removed from total forecast error used in the MIRFE calculation.

Depicted below are an example of particular steps and parameters gathered from the history 154 and applied to generate the orders 120 for restocking. Alternate configurations may employ other calculations and parameters for implementing the disclosed system and method. In the example below, the DRIST Model computes a daily SS quantity using a series of calculations based on DOW POS history and DOW forecasts. The following steps demonstrate these calculations in the sequence required for a weekly batch program that would set new SS targets by DOW.

Step 1: Calculate Daily Total Forecast Error™ (DTFE™)

The Daily Total Forecast Error™ (DTFE™) is a number calculated for each SKU (each product at each location) for each day of the 4 to 8 weeks of history that will be used to analyze forecast error, and from which the daily safety stock quantity (SS_{DOW}™) will be computed.

DTFE™=FC−POS

Where:
FC=Forecast Qty=the historic forecast used to generate the demand requirements for each day; often it is allocated to a daily quantity by percentage from the weekly demand forecast
POS=Actual Qty=the actual daily point-of-sale (POS) sales quantity recorded for each day
DTFE™ is null if either FC or POS is null

Step 2: Calculate Day-of-the-Week Forecast Bias™ (DOWFB™)

The DOW Forecast Bias™ (DOWFB™) is a number calculated for each SKU (each product at each location) for each day-of-the-week (DOW™) for the 4 to 8 weeks of history that will be used to analyze forecast error. For each DOW:

DOWFB™=AVERAGE (FC)−AVERAGE (POS)

For Tcalc>Tcrit otherwise DOWFB™=0

### Where:

Tcalc=ABS(DOWFB™)/(Standard Deviation (DTFE™)/(SQRT(NWH)))
NWH=number of weeks of history=number of non-null DTFE values for each DOW
DF (Degrees of Freedom)=NWH-1
Tcrit=values from 2-tailed t-Test for 80% confidence level:
   For DF=0, Tcrit=999999
   For DF=1, Tcrit=3.078
   For DF=2, Tcrit=1.885
   For DF=3, Tcrit=1.637
   For DF=4, Tcrit=1.533
   For DF=5, Tcrit=1.476
   For DF=6, Tcrit=1.439
   For DF=7, Tcrit=1.411

Step 3: The Daily Random Forecast Error™ (DRFE™)

The Daily Random Forecast Error (DRFE™) is a number calculated for each SKU (each product at each location) for each DOWT™ of the 4 to 8 weeks of history that will be used to analyze forecast error. It is simply the Daily Total Forecast Error minus the appropriate Day-of-the-Week Forecast Bias:

DRFE™=DTFE™−DOWFB™

Step 4: The Variable Order Interval™ (VOI™)

The Variable Order Interval™ (VOI™) is a duration in days, calculated for each SKU for each Day, based on when the next order is scheduled to be placed. For daily ordering, the VOI™=1. If the next Ordering Day is not until the day after tomorrow, the VOI™=2. For each day of the plan period (NPD) calculate the number of days to the next order date based on OP (Order Pattern):

VOI™=number of days to next OP day

Step 5: The Variable Forecast Interval™ (VFI™)

The Variable Forecast Interval™ (VFI™) is a duration in days, calculated for each SKU, based on the total lead time from order to delivery, plus the Variable Order Interval. The VFI™ reflects the period during which forecast error must be covered by safety stock before the next ordering opportunity for each day of the NPD:

VFI™=LT+VOI

Step 6: The Aggregated VFI Error™ (AVFIE™)

The Aggregated VFI Error™ (AVFIE™) is calculated as the algebraic sum of all the DRFE™ counting back from the day of arrival over the VFI™, calculated for each of the NWH historic weekly periods, by DOW™, for each SKU:

AVFIE_{DOW}=Σ(DRFE_{DOW}) for i=VFI to 1 by −1

Step 7: The Sum of Squares Random Forecast Error™ (SSRFE™)

The Sum of Squares Random Forecast Error™ (SSRFE™) is calculated across NWH, number of all non-null historic Forecast Intervals, from the AVFIE™, by DOW™, for each SKU:

SSRFE_{DOW}=Σ(AVFIE_{DOW})² for i=1 to NWH by 1

Step 8: The Mean Interval Random Forecast Error™ (MIRFE™)

The Mean Interval Random Forecast Error™ (MIRFE™) is calculated as the square root of the sums of squared error (of all NWH SSRFE™ sums of squared errors) by DOW™, for each SKU:

MIRFE_{DOW}=SQRT((SSRFE_{DOW})/NWH)

Where:

NWH=No. historic weekly periods

Step 9: The VOI Forecast Bias™ (VOIFB™)

The VOI Forecast Bias™ (VOIFB™) is calculated as the summation of DOWFB™ over the VOI™, by DOW™, for each SKU:

VOIFB_{DOW}=Σ(DOWFB_{DOW}) for i=1 to VOI

Step 10: The DRIST Safety Stock Quantity by Day-of-the-Week (SS_{DOW}™) is derived

Finally, the DRIST™ Safety Stock Quantity by Day-of-the-Week (SSDOW™), for each day of arrival, is calculated as the sum of the MIRFE™ and the VOIFB™, by DOW™, for each SKU for each day over the NPD:

SS_{DRIST}=Z*MIRFE_{DOW}+VOIFB_{DOW}

Where:
Z=Two-tailed Normal Distribution for Service Level (SL) target; for example, the following are just a few of the more common settings:
   For 85% SL, Z=1.036
   For 90% SL, Z=1.282
   For 95% SL, Z=1.645
   For 98% SL, Z=2.054
   For 99% SL, Z=2.326
      The orders 120 are generated by computing, for each item, a summation of the forecast bias for each sales period of the variable order interval, computing a safety stock based on the summed forecast bias and the mean interval forecast deviation, and rendering, for each item and each sales period, an order quantity based on the computed safety stock in the form of the order 120 sent to the vendor or distribution center 130.

The Z-factor, discussed above, is responsive to the user via the Service Target percentage for user-specified sets of SKUs. A planner can set Service Targets in whatever ways the business has segmented their product line. So, any given set of products, whether by department, by velocity, by strategic importance, and/or by demand variability, can have the most appropriate Service Target. Each set of SKUs, even down to individual SKUs, can be individually set with the most appropriate target Service Target for the business.

In fact, Service Targets can even be “time-phased” so that future periods may have a different Service Target than the current period. This time-phasing enables the planner to set Service Targets correctly for month-end, quarter-end, or year-end periods when there may be a need to precisely control and reduce inventories. On the other hand, if a planner needs to build inventories, for example to anticipate a shut-down of a providing production plant, the future Service Target can be increased.

With the DRIST model, the planner or manager controls the Service Target as the single lever for optimized inventory control. The planner does not need to create a forward coverage safety stock factor or compute a safety stock level in sidebar calculations or based on anecdotal past experience. The Service Target is the only setting the planner needs to manage.

In an example arrangement, the above method may be implemented in a standalone application, or integrated in a host application such as a spreadsheet or inventory system.

It will be appreciated by those skilled in the art that alternate configurations of the disclosed invention include a multiprogramming or multiprocessing computerized device such as a workstation, handheld or laptop computer or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a non-transitory computer readable storage medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

What is claimed is:

1. A method of managing inventory comprising:
identifying an inventory service target indicative of a percentage of stock SKUs available at a particular time, the stock SKUs denoting an item regularly available from the managed inventory and the service target indicative of the percentage of SKUs for which at least one unit is in stock;
computing, based on an aggregation of previous sales periods in a sales cycle, a forecast error and quantity of each SKU sold from the inventory prior to a successive replenishment of inventory; and
maintaining, based on the computed quantity, a stock level of each SKU at the lowest level while maintaining a non-zero inventory of a percentage of the SKUs based on the service target.

2. The method of claim 1 wherein the sales cycle defines a sequence of sales periods, the aggregation of previous sales periods including a set of corresponding sales periods in the sales cycle independently of other sets of sales periods, the corresponding sales periods defined by similar positions in the sequence.

3. The method of claim 2 wherein the sales cycle is a week and the sales periods are days within the week, the corresponding sales periods defined by one of the days of the week for a sample of previous weeks.

4. The method of claim 3 wherein the sample includes between 4-7 previous weeks of corresponding days.

5. The method of claim 1 further comprising:
assigning, for each SKU of the set of regular stock items, a unique identifier denoting the particular SKU; and
invoking a replenishment mechanism for the SKU corresponding to each of the unique identifiers by computing a variable forecast interval based on lead times and a variable order interval based on an order cycle, applying a forecast error indicative of variations in expected demand, each SKU having an independent forecast error for each sales period.

6. The method of claim 5 further comprising:
computing, for each SKU and each sales period, a forecast based on a predicted sales volume and an actual sales volume;
computing, for each SKU and each sales period, a forecast bias based on a difference between the average forecast and the average actual sales volume for a sample period;
identifying a forecast bias if the computed difference is significant, the forecast bias representing non-random error; and
computing a daily random forecast error based on subtracting the forecast bias from a total forecast error.

7. The method of claim 6 further comprising:
identifying a variable forecast interval based on variances in the sales period demand and resupply variations; and
computing the maintained stock level based on the identified variable forecast interval.

8. The method of claim 7 further comprising computing an aggregated forecast variation by summing the forecast error and forecast bias for each sales period for each SKU.

9. The method of claim 8 further comprising:
computing, for each SKU, and for each previous sales period in the sales cycle, a sum of squares of the aggregated forecast variation; and
computing a square root of the computed sum of squares to determine a mean interval forecast deviation indicative of variation of the sales period for recent sales.

10. The method of claim 9 further comprising
computing, for each SKU, a summation of the forecast bias for each sales period of the variable order interval;
computing a safety stock based on the summed forecast bias and the mean interval forecast deviation; and
rendering, for each SKU and each sales period, an order quantity based on the computed safety stock.

11. The method of claim 10 further comprising:
receiving a request to render an order quantity for at least one of the SKUs;
sending a generated order that includes safety stock requirements to a replenishment facility operable to arrange a shipment based on the order.

12. The method of claim 5 wherein the sales period corresponds to a day of the week and the sales cycle corresponds to a week; and
the unique identifier denotes a type of product at a location.

13. In an inventory management environment having inventory statistics, the inventory statistics specific to each day of the week, a method of computing target inventory levels comprising:
gathering, for each day of the week, inventory level statistics from previous sales;
computing, based on the inventory level statistics, a safety stock for each day of the week, the safety stock independent of a safety stock for other days of the week such that the computed safety stock accommodates variations in inventory between the different days of the week; and
rendering, for each of a plurality of SKUs, a stocking level indicative of the target the safety stock for each day of the week.

14. The method of claim 13 further comprising computing an ordering quantity based on a lead time such that the ordered quantity arrives to satisfy the rendered stocking level on the determined day of the week.

15. The method of claim 14 wherein identifying the actual stock levels includes identifying stock levels on the day of the week for a plurality of previous weeks.

16. A computer program product having instructions stored on a non-transitory computer readable storage medium for performing, in an ordering environment having at least one SKU, each SKU denoting an item at a location, a method for computing an inventory quantity for each SKU, the method comprising:
gathering, for each SKU, a history of inventory sold
computing an expected bias, the bias based on the history;
identifying, for each SKU, a deviation range of the expected quantity for each period;
aggregating, for the periods remaining until a replenishment of inventory, the deviation range; and
computing the safety stock based on the bias and an aggregation of the deviation range.

17. The method of claim 16 wherein the expected quantity sold for each day of the week is independent of the others of the days of the week.

18. The method of claim 17 wherein the deviation range includes a safety stock computed based on the bias for each day and a variance for each day.

19. The method of claim 18 wherein aggregating the deviation range includes an aggregation of a forecast deviation for each day in the current ordering interval until a successive delivery of additional inventory for the SKU.

20. The method of claim 19 wherein the deviation range is based on a statistical parameter for maintaining a target percentage of all SKUs in stock.

21. An inventory management server, comprising:
a user interface device responsive to an ordering environment having at least one SKU, the SKU denoting an item for sale at a location;
a processor for computing a safety stock for each SKU;
a storage repository for gathering, for each SKU, a history of inventory sold;
the processor configured to, for each SKU,
compute an expected bias, the bias based on the history;
identify for each SKU, a deviation range of the expected quantity for each period;
aggregate, for the periods remaining until a replenishment of inventory, the deviation range; and
compute the safety stock based on the bias and an aggregation of the deviation range.
